(19) United States
(12) Patent Application Publication
(10) Pub. No.: US 2010/0149113 A1
(43) Pub. Date: Jun. 17, 2010

(54) PROXIMITY SENSOR DEVICE, ELECTRONIC APPARATUS AND METHOD OF SENSING OBJECT PROXIMITY

(75) Inventor: Bjorn HANSSON, Sollentuna (SE)

Correspondence Address: EDWARDS ANGELL PALMER & DODGE LLP, P.O. BOX 55874, BOSTON, MA, 02205, US

(73) Assignee: SONY ERICSSON MOBILE COMMUNICATIONS AB, Lund (SE)

(21) Appl. No.: 12/334,632

(22) Filed: Dec. 15, 2008

(51) Int. Cl. G06F 3/041

(52) U.S. Cl. 345/173

(57) ABSTRACT

A proximity sensor device, a portable electronic apparatus and a method of sensing object proximity are disclosed. The proximity sensor device comprises a light source and a layer optically coupled to the light source. Light output by the light source is transmitted in the layer. The layer comprises an output coupler configured to couple at least a portion of the light transmitted in the layer out of the layer.

### FIELD OF THE INVENTION

The invention relates to a proximity sensor, an electronic apparatus and a method of sensing object proximity. The invention relates in particular to a proximity sensor that uses optical signals to detect object proximity and an electronic apparatus employing the same.

### BACKGROUND OF THE INVENTION

Electronic apparatuses, such as portable electronic apparatuses, frequently comprise a user interface that allows a user to enter control commands or other data. While some conventional user interfaces, such as a keypad or a touch-sensitive sensor, may be responsive to a user touching the user interface, in some electronic apparatuses it may be desirable to detect proximity of an object to the electronic apparatus. Based on whether an object is located in proximity to the electronic apparatus or not, a process may be activated in the electronic apparatus. Examples for portable electronic apparatuses in which it may be desirable to sense object proximity include mobile phones, cordless phones, personal digital assistants (PDAs), cameras, portable music players and similar. Examples for proximity sensors include sensors that provide a binary signal indicative of whether or not an object is present in proximity to the electronic apparatus, and sensors that may be configured to provide a signal indicative of a position of the object.

One implementation of a proximity sensor may be based on the emission of optical signals and the detection of reflected optical signals. In order to integrate an optical proximity sensor into a portable electronic apparatus, it may be required to provide an opening in a housing of the apparatus in order to allow light to be emitted to the outside of the housing and reflected light to be received within the housing. Such openings may negatively affect the optical appearance of the portable electronic apparatus. It would be desirable to provide a proximity sensor which allows the appearance of an electronic apparatus to be enhanced and which does not require a dedicated opening for emitting light from the housing.

### SUMMARY OF THE INVENTION

Accordingly, there is a need for a proximity sensor, an electronic apparatus and a method of sensing object proximity which obviate at least some of the above-mentioned drawbacks.

According to an aspect of the invention, a proximity sensor device is provided which comprises a light source configured to output light and a layer optically coupled to the light source. The layer is configured to receive the light output by the light source and to transmit the light in the layer. The layer comprises an output coupler which is configured to couple at least a portion of the light transmitted in the layer out of the layer.

In a proximity sensor device in which light is transmitted in a layer and coupled out of the layer by an output coupler, light may be emitted from the layer via the output coupler.

In an embodiment, the proximity sensor device may comprise an electro-optical sensor configured to detect a reflected portion of the light coupled out of the layer.

In an embodiment, the layer may further comprise an input coupler configured to couple light into the layer. The electro-optical sensor may be optically coupled to the layer to receive at least a portion of the light coupled into the layer. When the layer comprises an input coupler, the reflected portion of the light may be coupled into and transmitted in the layer.

In an embodiment, the input coupler and the output coupler may be integrally formed as a grating coupler.

In an embodiment, the layer may further comprise a beam splitter configured to direct the light output by the light source to the grating coupler and to direct the light coupled into the layer to the electro-optical sensor.

In an embodiment, the proximity sensor device may comprise a processor coupled to the electro-optical sensor and configured to determine based on an output signal of the electro-optical sensor whether an object is located in proximity to the layer.

In an embodiment, the light source may be configured to output the light with a wavelength in the infrared spectral range.

In an embodiment, the light source may be configured to output a sequence of light pulses with a wavelength in the infrared spectral range.

In an embodiment, the layer may define a plane and the output coupler may be configured to direct the light out of the plane. The layer may be a planar layer provided in an outer shell of a portable electronic apparatus.

In an embodiment, the layer may be a layer of a touch-sensitive device.

In an embodiment, the proximity sensor device may further comprise a display panel arranged to co-extend with the layer. The layer may be transmissive in the visible spectral range.

According to another aspect, a proximity sensor device is provided. The proximity sensor device comprises a layer configured to transmit light therein, a light source and an electro-optical sensor. The layer comprises a plurality of output couplers. Each output coupler of the plurality of output couplers may be configured to couple light out of the layer. The layer further comprises at least one input coupler. Each input coupler of the at least one input coupler may respectively be configured to couple light into the layer. The light source is optically coupled to the layer and configured to output light to said layer. The at least one electro-optical sensor is optically coupled to the layer and configured to detect at least a portion of the light coupled into the layer by the at least one input coupler.

In an embodiment, the proximity sensor device may comprise a processor configured to determine at which input coupler the light detected by the at least one electro-optical sensor is coupled into the layer.

In an embodiment, the plurality of output couplers and the at least one input coupler may be configured as an array of input/output coupler gratings. The output couplers and input couplers may be integrally formed as focusing grating couplers.

According to another aspect, an electronic apparatus is provided which comprises a proximity sensor device. The proximity sensor device comprises a light source configured to output light and a layer optically coupled to the light source to receive the light output by the light source and configured to transmit the light output by the light source in the layer. The layer may comprise an output coupler configured to couple at least a portion of the light transmitted in the layer out of the layer.

In the electronic apparatus, the proximity sensor device allows proximity of an object to the portable electronic apparatus to be sensed.

In an embodiment, the layer of the proximity sensor device may be integrated into an outer shell of the electronic apparatus.

According to an aspect, a method of sensing proximity of an object is provided. In the method, light is transmitted in a layer. At least a portion of the light transmitted in the layer is coupled out of the layer. A reflected portion of the light coupled out of the layer is detected. Based on the detected reflected portion it is determined whether the object is located in proximity to the layer.

In an embodiment, the reflected portion may be coupled back into the layer.

In an embodiment, the method may further comprise determining a location at which the reflected portion is coupled back into the layer.

The method may be performed using a proximity sensor device according to any one aspect or embodiment.

It is to be understood that the features mentioned above and features yet to be explained below can be used not only in the respective combinations indicated, but also in other combinations or in isolation, without departing from the scope of the present invention. Features of the above-mentioned aspects and embodiments may be combined in other embodiments.

### BRIEF DESCRIPTION OF THE DRAWINGS

The foregoing and additional features and advantages of the invention will become apparent from the following detailed description when read in conjunction with the accompanying drawings, in which like reference numerals refer to like elements.

FIG. 1 is a schematic block diagram representation of a portable electronic apparatus according to an embodiment.

FIG. 2 is a schematic view of a proximity sensor device according to an embodiment.

FIG. 3 is a schematic view of the proximity sensor device of FIG. 2 for further illustration of the operation of the proximity sensor device.

FIG. 4 is a schematic view of a proximity sensor device according to another embodiment.

FIG. 5 is a flow diagram representation of a method of sensing object proximity according to an embodiment.

FIG. 6 is a schematic view of a proximity sensor device according to another embodiment.

FIG. 7 is a schematic view of a proximity sensor device according to another embodiment.

FIG. 8 is a flow diagram representation of a method of sensing object proximity according to another embodiment.

FIG. 9 is a schematic partial view of a portable electronic apparatus provided with a proximity sensor device according to an embodiment.

FIG. 10 is a schematic view of a portable electronic apparatus provided with a proximity sensor device according to another embodiment.

FIG. 11 is a schematic cross-sectional view of an arrangement comprising a proximity sensor device according to an embodiment.

FIG. 12 is a flow diagram representation of a method of controlling an electronic apparatus which includes proximity sensing according to an embodiment.

### DETAILED DESCRIPTION OF THE INVENTION

In the following, embodiments of the present invention will be described in detail with reference to the accompanying drawings. It is to be understood that the following description of embodiments is given only for the purpose of illustration and is not to be taken in a limiting sense. The scope of the invention is not intended to be limited by the embodiments described hereinafter or by the drawings, which are taken to be illustrative only. Rather, the scope of the invention is intended to be defined only by the appended claims and equivalents thereof.

It is to be understood that the drawings are to be regarded as being schematic representations only, and elements illustrated in the drawings are not necessarily shown to scale. Rather, the various elements are represented such that their function and general purpose become apparent to a person skilled in the art.

It is also to be understood that, in the following description of exemplary embodiments, any direct connection or coupling between functional blocks, devices, components or other physical or functional units shown in the drawings or described herein may also be implemented by an indirect connection or coupling. Functional block may be implemented in hardware, firmware, software or a combination thereof.

Further, it is to be understood that the features of the various exemplary embodiments described herein may be combined with each other, unless specifically noted otherwise.

Proximity sensor devices and electronic apparatuses provided with a proximity sensor device according to several embodiments will be described, in which a proximity sensor device comprises a layer and a light source configured to output light into the layer. The layer comprises an output coupler configured to couple light out of the layer. In a proximity sensor device in which light is transmitted in a layer and coupled out of the layer by an output coupler, light may be emitted from the layer without requiring an opening for light emission. When the proximity sensor device is used, for example, in a portable electronic apparatus, the layer may be integrated in the outer shell of the portable electronic apparatus. The region in which proximity of an object may be sensed may be selected by appropriately positioning the output coupler in the layer.

As used in the context of several embodiments, the term ‘proximity sensor device’ generally includes both proximity sensors configured as proximity switches which output a binary signal indicative of whether or not an object is present in proximity to a location, and proximity sensors which output a signal that may include additional information, such as information on a position or distance of the object. As used in the context of several embodiments, the term ‘light’ also includes light having a wavelength in portions of the optical spectrum not visible to the human eye. For illustration rather than limitation, the light source may be configured to output light in the infrared spectral range, and the layer may be configured to transmit light in the infrared spectral range. As used in the context of several embodiments, the term ‘reflected light’ or ‘reflected portion of light’ generally includes any reflection or scattering off an object, including, for example, diffuse reflection. Still further, as used in the context of several embodiments, terms such as ‘transmission of light in a layer’, ‘light is transmitted in a layer’ or similar refer to a process in which optical energy is transported essentially in a plane defined by the layer. However, these terms neither imply nor require that all light energy is losslessly transmitted in the layer. Rather, in some embodiments the layer may also absorb a portion of the light and/or a portion of the light may leak out of the layer and/or may be reflected or scattered off a surface of the layer.

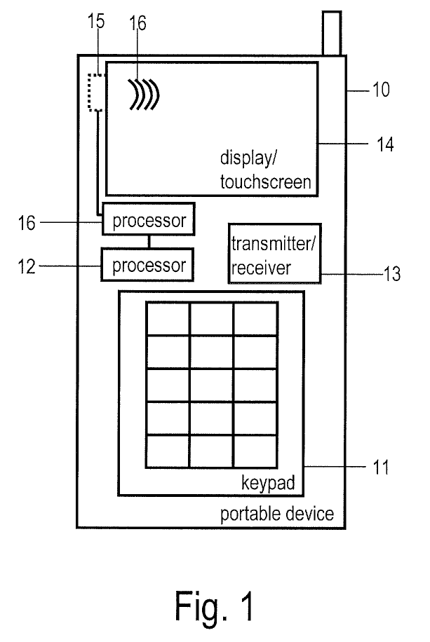

FIG. 1 is a schematic block diagram representation of a portable electronic apparatus 10 in which a proximity sensor device according to an embodiment may be implemented. The portable electronic apparatus 10 comprises a keypad 11 which allows a user to input commands or data into the electronic apparatus 10. The electronic apparatus 10 further comprises a transmitter/receiver device 13, a processor 12 and a display 14 that may be integrally formed with a touch screen. The processor 12 may be operable to control operation of various components of the portable electronic apparatus 10, such as the transmitter/receiver device 13 or the display. The processor 12 may be further operable to control the display or other components of the portable electronic apparatus 10 based on whether the proximity sensor device senses proximity of an object.

In exemplary embodiments, the portable electronic apparatus 10 may be configured as one of a mobile phone, a cordless phone, a personal digital assistant (PDA), a portable music player, a camera, or similar. While the portable electronic apparatus 10 illustrated in FIG. 1 comprises a transmitter/receiver device 13 and is configured for wireless communication, in other embodiments a proximity sensor device according to an embodiment may be implemented in a portable electronic apparatus that may not be configured for communication purposes.

The portable electronic apparatus 10 further comprises a proximity sensor device. The proximity sensor device comprises a unit 15 including a light source and an electro-optical sensor which are respectively optically coupled to a layer of the display and touch screen 14. A light input/output coupler 16 is formed in the layer. In an embodiment, the light source and electro-optical sensor of the unit 15 may be optically coupled to a top, or outermost layer, of the display and/or touch screen 14, and the light input/output coupler 16 may be provided in the top layer of the display and/or touch screen 14. The proximity sensor device may further comprise a processor 17 which is coupled to the light source and the electro-optical sensor of the unit 15 to control operation of the light source and to evaluate an output signal of the electro-optical sensor, respectively. In other embodiments, electrical components implementing a processing circuit for the unit 15 may be coupled to the light source and/or the electro-optical sensor of the unit 15 to control operation of the light source and/or to evaluate an output signal of the electro-optical sensor, respectively. In the following, reference will be made to a ‘processor’ coupled to the light source and/or the electro-optical sensor, it being understood that the processor may, but does not need to be a general purpose processor, and that the processor may also be implemented by electrical components forming a processing circuit.

As will be explained in more detail with reference to exemplary embodiments below, in operation of the proximity sensor device the processor 17 controls the light source of the unit 15 to emit light. The light emitted by the light source is transmitted in the layer to the input/output coupler 16, which directs at least a portion of the light out of the layer. Depending on whether an object is located in proximity to the layer of the display and/or touch screen 14, or more specifically, in proximity to the input/output coupler 16 formed in the layer, the electro-optical sensor of the unit 15 may receive a reflected portion of the light which is coupled out of the layer and then reflected at a surface of the object. Based on an output signal of the electro-optical sensor, the processor 17 may determine whether or not an object is located in proximity to the layer.

The processor 17 is coupled to the processor 12 to provide thereto a signal indicative of whether the proximity sensor device has sensed object proximity. In some embodiments, the signal provided by the processor 17 to the processor 12 may include additional information, such as information on a distance of the object from the layer or information on a lateral position of the object along directions parallel to the layer. Depending on the output signal of the processor 17, the processor 12 may activate one of various processes in the electronic apparatus 10. For illustration rather than limitation, when the portable electronic apparatus 10 is a mobile phone, object proximity sensed at a location near a loud-speaker of the mobile phone may indicate that a user intends to use the mobile phone for making a telephone call, and that the ear of the user is close to the loudspeaker. In this case, the processor 12 may de-activate a background light of the mobile phone or the display of the mobile phone. Alternatively or additionally, the processor 12 may deactivate the keypad 11. Such processes may help saving mobile phone battery and avoiding unintentional activation of, for example, keys of the keypad 11 while a phone call is being made with the mobile phone. In another embodiment, the proximity sensor device may be integrated in a user interface. Examples for processes that may be initiated when the proximity sensor device of a user interface senses the proximity of an object may include the selection of items displayed on the display 14, browsing through file structures displayed on the display 14, or the initiation of a control process, such as setting up a telephone connection, opening a phone book, or similar.

While the processor 17 of the proximity sensor device is schematically illustrated in FIG. 1 as a component separate from the main processor 12 of the portable electronic apparatus 10, the functions of controlling the light source of the proximity sensor device and of evaluating an output signal of the electro-optical sensor may also be performed by the main processor 12 of the portable electronic apparatus. As indicated above, the processor in any one of the embodiments may also be implemented by electric components which form a processing circuit coupled to the light source and/or the electro-optical sensor.

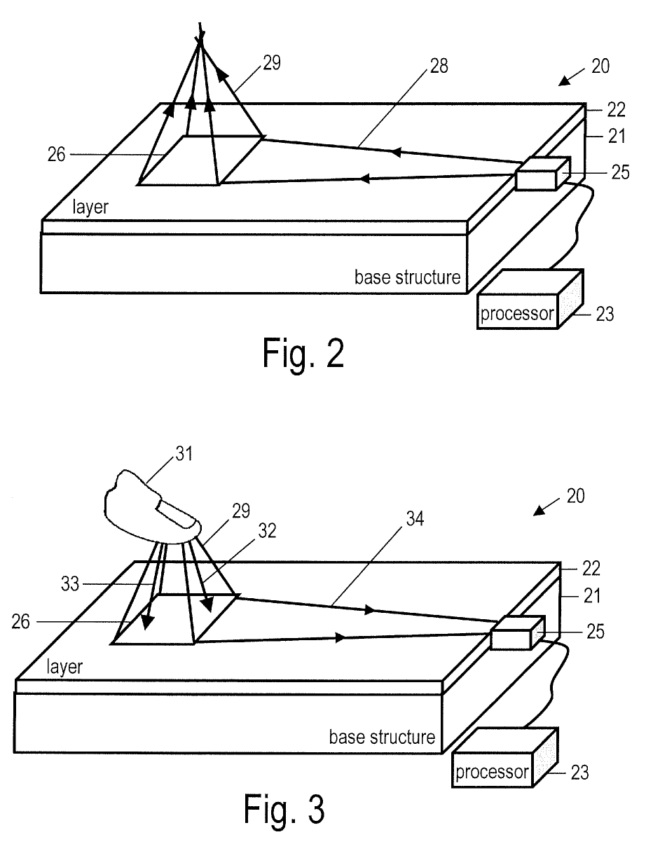

With reference to FIGS. 2-12, proximity sensor devices and methods of sensing object proximity according to embodiments will be described in more detail. The proximity sensor devices may be implemented in a portable electronic apparatus, such as the portable electronic apparatus 10 of FIG. 1. Similarly, the methods of sensing object proximity may be performed with the portable electronic apparatus 10 of FIG. 1.

FIGS. 2 and 3 are schematic views of a proximity sensor device 20 according to an embodiment. FIG. 3 illustrates the proximity sensor device 20 in a state in which an object 31 is located in proximity to the proximity sensor device 20, so that object proximity is sensed.

The proximity sensor device 20 comprises a layer 22 and a light source and an electro-optical sensor which are integrated in a combined light source and electro-optical sensor unit 25. In the illustrated embodiment, the proximity sensor device 20 further comprises a processor 23, which may be implemented as a general purpose processor or another processing circuit, coupled to the light source and electro-optical sensor unit 25 in order to control operation of the light source and in order to evaluate an output signal of the electro-optical sensor. The layer 22 is provided with an input/output coupler 26 to couple light transmitted in the layer 22 out of the layer 22, and to couple light incident on the input/output coupler 26 at an angle relative to the plane of the layer 22 into the layer 22. In one exemplary embodiment, the layer 22 may be supported on a base structure 21 on one side, while the opposite side of the layer 22 may be in contact with air, and the input/output coupler 26 may be configured to couple light transmitted in the layer 22 into the air, and to couple light incident on the input/output coupler from the air into the layer 22.

In operation of the proximity sensor device, the light source of the unit 25 may generate and output light. The light source may be configured for example as a light-emitting diode (LED). The emitted light may, but does not need to have a wavelength that corresponds to visible light. In one embodiment, the light source may be operable to output light having a wavelength in the infrared spectral range. When the light source outputs infrared light, the proximity sensor device does not generate visible output signals that may disturb, for example, a human user. Further, power consumption of the proximity sensor device 20 may be reduced.

The layer 22 is operable to transmit the light output by the light source in the layer toward the input/output coupler 26, as indicated at 28 in FIG. 2. While in one embodiment the layer 22 may be configured to have wave-guiding properties for the light output by the light source, in another embodiment a portion of the light output by the light source may be scattered, reflected or leak out of the layer on its way toward the input/output coupler 26. In one embodiment, the optical properties of the layer 22 and the location of the input/output coupler 26 in the layer are selected such that a portion of the light output by the light source is transmitted to the input/output coupler 26 which is sufficiently large to provide detectable reflected light signal levels when an object is located in proximity to the input/output coupler 26.

The input/output coupler 26 is configured to couple at least a portion of the light 28 transmitted in the layer 22 out of the layer 22, as indicated at 29. In one embodiment, the input/output coupler 26 may comprise local changes in the index of refraction of the layer 22. Local changes in the index of refraction may be created in various ways, for example by exposing the layer 22 to ultraviolet radiation, by ion-exchange, by locally depositing material on the layer 22, by locally removing material from the layer 22, etc. In one embodiment, the input/output coupler 26 may be configured as a grating coupler. The grating coupler may be configured such that it couples light having the wavelength emitted by the light source out of the layer and into the layer, respectively, but has a lower coupling efficiently for light having wavelengths significantly different from the wavelength output by the light source. For illustration rather than limitation, in one embodiment the grating coupler may be configured such that it efficiently couples light having a wavelength in the infrared spectral range out of the layer and into the layer, but does not significantly refract light in the visible spectral range. In one embodiment, the grating coupler may be configured such that most of the light incident on the grating coupler in the layer is coupled out of the layer. In another embodiment, the grating coupler may be configured such that a fraction of the light incident on the grating coupler is coupled out of the layer which is sufficiently large to provide detectable reflected light signal levels when an object is located in proximity to the input/output coupler 26.

The input/output coupler 26 may be configured as a focusing grating coupler. The focusing grating coupler may be implemented using local changes in the index of refraction of the layer 22, which changes may have a curved shape. The focusing grating coupler may be configured such that at least a portion of the light 28 incident on the focusing grating coupler in the layer 22 may be coupled out of the layer 22 in convergent light beams or in essentially parallel light beams, thereby defining a volume 29 above the layer 22 into which the light is coupled out of the layer 22 by the input/output coupler 26.

With reference to FIG. 3, when an object 31 is located in the volume 29, a portion of the light is reflected off the surface of the object 31 toward the input/output coupler 26, as schematically indicated by light beams 32 and 33 in FIG. 3. It is to be understood that light may be reflected off the surface of the object 31 and back toward the input/output coupler 26 by any one of the various mechanisms that allow light to be reflected back toward the input/output coupler 26, including diffuse reflection, scattering and similar.

The input/output coupler 26 couples the reflected portion of the light back into the layer 22, where it is transmitted toward the light source and electro-optical sensor unit 25. When the input/output coupler 26 is configured as a focusing grating coupler, the reflected portion of the light may be transmitted toward unit 25 in a convergent beam 34. The electro-optical sensor of the unit 25 may detect the reflected portion of the light coupled back into the layer 22. In one embodiment, the electro-optical sensor may be a wavelength-selective electro-optical sensor configured to detect light in a range of wavelengths that includes the wavelength emitted by the light source of the unit 25. For illustration rather than limitation, the electro-optical sensor of the unit 25 may be configured such that it has a high detection efficiency in the infrared spectral range, but is less sensitive in at least a portion of the visible spectrum.

An output signal of the electro-optical sensor of the unit 25, which is indicative of a light intensity detected by the electro-optical sensor, is provided to the processor 23. The processor 23 evaluates the output signal of the electro-optical sensor to determine whether an object is located within the region 29.

In order to allow the reflected portion of the light to be discriminated from other light detected by the electro-optical sensor, such as background light, the processor 23 may control the light source to generate a pulsed light signal. The processor 23 may further be configured to correlate in time the output signal of the electro-optical sensor with the light signal generated by the light source. For illustration rather than limitation, the processor 23 may be configured to compare the output signal of the electro-optical sensor in a time interval or several time intervals in which no light is output by the light source with the output signal of the electro-optical sensor in a time interval or several time intervals in which the light source outputs light. A difference signal of the two signal levels may be attributed to a reflection at the surface of the object 31.

The proximity sensor device 20 of FIGS. 2 and 3 is operable to optically sense object proximity. As light output by the light source is transmitted in the layer 22 and coupled out of the layer 22 via the input/output coupler 26, no dedicated light output opening may need to be provided in a housing of a portable electronic apparatus that includes the proximity sensor device. Similarly, as light reflected off the object 31 is coupled into the layer 22 via the input/output coupler 26 and is transmitted in the layer 22, no dedicated light input opening may need to be provided in a housing of a portable electronic apparatus that includes the proximity sensor device. Thereby, the optical appearance of the electronic apparatus may be enhanced. Still further, as light is coupled out of the layer and back into the layer via the input/output coupler, object proximity may be locally sensed in a volume located essentially above the input/output coupler. This allows object proximity to be sensed at specific locations, such as close to a loudspeaker of a mobile phone.

When the proximity sensor device 20 of FIGS. 2 and 3 is used in a portable electronic apparatus, such as the portable electronic apparatus 10 of FIG. 1, components of the proximity sensor device 20 may be integrally formed with other components of the portable electronic apparatus. For illustration, the main processor of the portable electronic apparatus may perform the functions of the processor 23 of the proximity sensor device 20. For further illustration, the layer 22 of the proximity sensor device may be integrated in an outer shell of the portable electronic apparatus, and may be comprised by or otherwise associated with other functional entities of the portable electronic apparatus. In one embodiment, the layer 22 may be a layer of a touch-sensitive device, such as a touch pad, a touch screen, a resistive touch screen, a capacitive touch screen, an in-cell touch screen, a touch window or similar. In another embodiment, the layer 22 may be a top layer disposed on an outer side of a display panel.

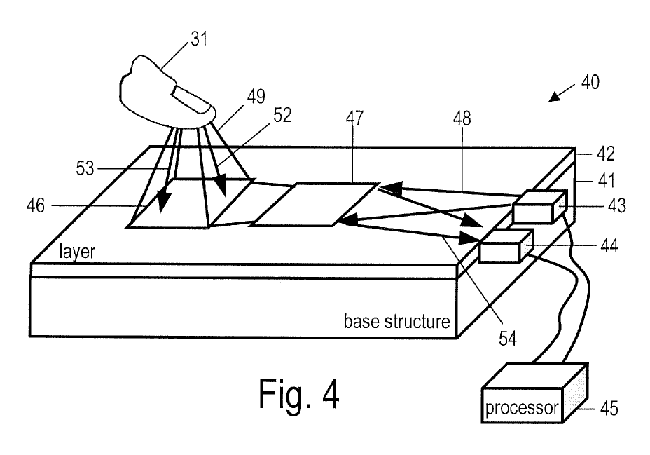

FIG. 4 is a schematic view of a proximity sensor device 40 according to another embodiment. The proximity sensor device 40 comprises a layer 42, a light source 43 and an electro-optical sensor 44. In the proximity sensor device 40, the light source 43 and the electro-optical sensor 44 are spatially separated. In the illustrated embodiment, the proximity sensor device 40 further comprises a processor 45 coupled to the light source 43 in order to control operation of the light source 43, and coupled to the electro-optical sensor 44 in order to evaluate an output signal of the electro-optical sensor 44. The processor 45 may be implemented as a general purpose processor or as electrical components forming a processing circuit. The layer 42 is provided with an input/output coupler 46 to couple light transmitted in the layer 42 out of the layer 42, and to couple light incident on the input/output coupler 46 at angle relative to the plane of the layer 42 into the layer 42. In one exemplary embodiment, the layer 42 may be supported on a base structure 41 on one side, while the opposite side of the layer 42 may be in contact with air, and the input/output coupler 46 may be configured to couple light transmitted in the layer 42 into the air, and to couple light incident on the input/output coupler 46 from the air into the layer 42.

In the proximity sensor device 40, the layer 42, the light source 43, the electro-optical sensor 44, the processor 45 and the input/output coupler 46 may have a configuration that corresponds to the configuration of the corresponding components in any one of the embodiments described with reference to FIGS. 2 and 3. For illustration, the light source 43 may be configured to output a pulsed light signal having a wavelength in the infrared spectral range, the layer 42 may be configured to transmit the light between the input/output coupier 46 and the light source 43 and the electro-optical sensor 44, respectively, the input/output coupler 46 may be configured to couple the light out of the layer 42 and to couple a reflected portion of the light back into the layer 42, and the electro-optical sensor 44 may be configured to detect the reflected portion of the light.

In the proximity sensor device 40, the layer 42 further comprises a beam splitter 47. The beam splitter 47 may comprise a local change in the index of refraction of the layer 42. The beam splitter 47 is configured to direct the light 48 output by the light source 43 and transmitted in the layer 42 toward the input/output coupler 46. The beam splitter 47 is further configured to direct the reflected portion of the light coupled into the layer 42 by the input/output coupler 46 toward the electro-optical sensor 44, as indicated at 54. Therefore, when the light source 43 outputs light 48 which is transmitted in the layer 42 toward the input/output coupler 46, the beam splitter 47 receives the light 48 and directs the light toward the input/output coupler 46, where the light is coupled out of the layer 42 into a volume indicated at 49. When an object 31 is located within the volume 49, a portion of the light 52, 53 is reflected toward the input/output coupler 46, for example by diffusive reflection at the object 31. The input/output coupler 46 couples the light 52, 53 incident on the input/output coupler 46 back into the layer 42. In the layer 42, the reflected portion of the light is transmitted from the input/output coupler 46 to the beam splitter 47, which directs the light toward the electro-optical sensor 44. An output signal of the electro-optical sensor 44 is provided to the processor 45, which evaluates the output signal to determine whether an object 31 is located in the volume 49 in proximity to the input/output coupler 46.

In one embodiment, the beam splitter 47 may be implemented as a focusing grating beam splitter. The grating may be formed, for example, by exposing the layer 42 to ultraviolet radiation, by ion-exchange, by locally depositing material on the layer 42, by locally removing material from the layer 42, etc., in order to effect a local change in refractive index in the layer 42.

The beam splitter 47 provided in the proximity sensor device 40 allows light coupled into the layer at the input/output coupler 46 to be spatially separated from light output from the light source 43 toward the input/output coupler 46, so that the electro-optical sensor 44 may be arranged so as to be spaced from the light source 43.

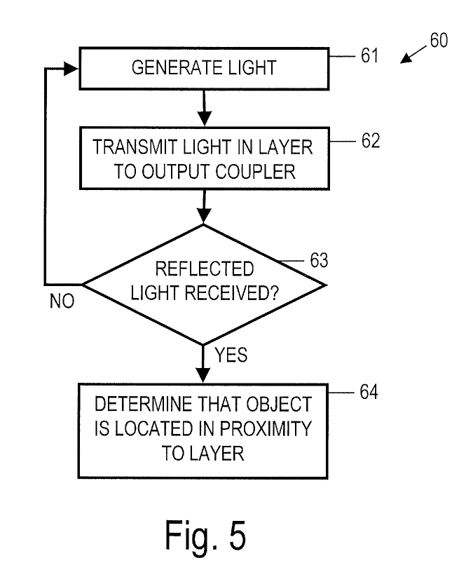

With reference to FIG. 5 a method of sensing proximity of an object according to an embodiment will be explained. The method is generally indicated at 60. The method may be performed by a proximity sensor device according to any one of the embodiments described with reference to FIGS. 2-4 above. The method may be used to sense proximity of an object in the portable electronic apparatus 10 of FIG. 1.

At 61, light is generated. The generated light may have a wavelength in the infrared spectral range. The generated light may comprise a series of infrared light pulses. At 62, the generated light is transmitted in a layer to an output coupler, which couples the light out of the layer. At 63 it is determined whether a reflected light signal is received. In one embodiment, the determining at 63 may comprise coupling light into the layer and transmitting the light in the layer to an electro-optical sensor. The determining at 63 may include comparing an intensity of received reflected light in a state in which no light is generated with an intensity of received reflected light in a state in which light is generated. The determining at 63 may further include comparing an intensity of received light with a threshold. If it is determined at 63 that no reflected light has been received, the method returns to generating light at 61. If it is determined at 63 that reflected light has been received, at 64 it is determined that an object is located in proximity to the layer.

Based on whether object proximity is detected in the method 60, one or several processes may be initiated in a portable electronic apparatus. For illustration rather than limitation, if the portable electronic apparatus is a mobile phone and the light is coupled out of the layer at a location near a loudspeaker of the mobile phone, a background light or display may be switched off or a keypad may be deactivated when object proximity is detected. In another embodiment, the proximity sensor device may be a component of a user interface, and a user-initiated action may be started when object proximity is detected.

While the layer of the proximity sensor devices schematically illustrated in FIGS. 2-4 include one input/output coupler, several input/output couplers may be provided in the layer of the proximity sensor device. By providing the layer of the proximity sensor device with several output couplers or several input couplers, additional information on object proximity may be captured. For illustration, by providing the layer with several output couplers or several input couplers, object proximity may be sensed in a spatially resolved manner.

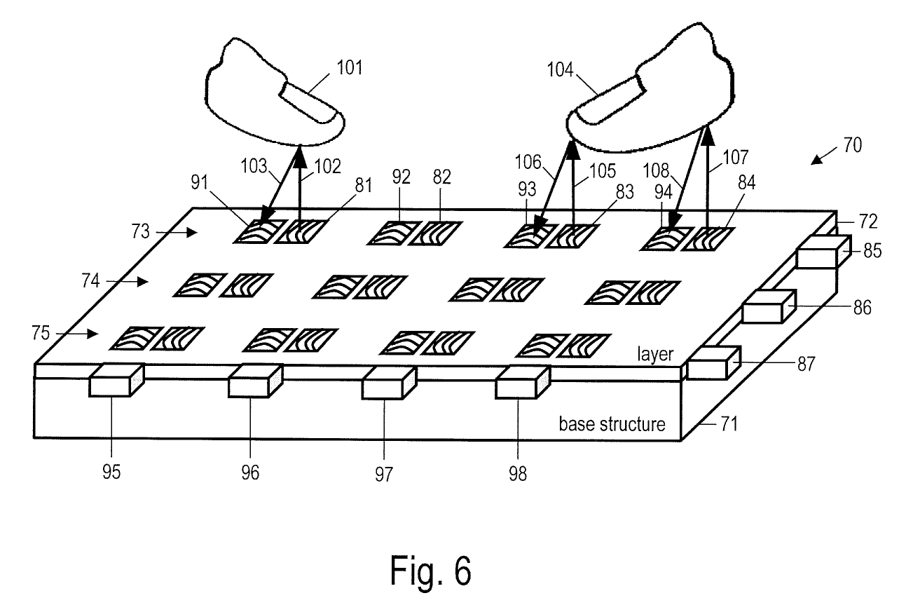

FIG. 6 is a schematic view of a proximity sensor device 70 according to an embodiment. The proximity sensor device 70 comprises a layer 72, a plurality of light sources 85-87 and a plurality of electro-optical sensors 95-98. The layer 72 is supported by a base structure 71. In the layer 72, a plurality of input/output couplers are provided.

In the proximity sensor device 70, the plurality of input/output couplers 81-84, 91-94 are arranged in a pairwise fashion in a plurality of rows 73-75 and in a plurality of columns. The regular arrangement of input/output couplers and the specific number of rows and columns shown in FIG. 6 is provided for illustration, and other arrangements of input/output couplers may be implemented in other embodiments.

In the illustrated arrangement of input/output couplers, each one of the input/output couplers 81-84, 91-94 may be configured as a focusing grating coupler. The focusing grating couplers 81-84, 91-94 may respectively be formed by local variations in the refractive index of the layer 72, as schematically indicated by curved lines in FIG. 6. The local variations in refractive index may be implemented, for example, by exposing the layer 72 to ultraviolet radiation, by ion-exchange, by locally depositing material on the layer 72, by locally removing material from the layer 72, etc. Each one of the focusing grating couplers 81-84, 91-94 may be configured to couple light transmitted in the layer 72 out of the layer or to couple light incident onto the respective focusing grating coupler 81-84, 91-94 at an angle relative to the plane of the layer 72 into the layer 72.

In one embodiment, one focusing grating coupler 81-84 in each one of the pairs of input/output couplers may be operable to couple light output by one of the light sources 85-87 and transmitted in the layer 72 out of the layer 72 in a focused light beam. The other focusing grating coupler 91-94 in each one of the pairs of input/output couplers may be configured to couple light into the layer 72 and to focus the light coupled into the layer toward one of the electro-optical sensors 95-98.

The focusing grating couplers 81-84 which are arranged in one row so as to receive light from respectively one of the light sources 85-87 are configured such that the focusing grating coupler 84 located closest to the respective light source 85 only couples a portion of the light transmitted in the layer 72 out of the layer 72, so that another portion of the light generated by the light source 85 may be transmitted onward to the focusing grating coupler 83. Similarly, the focusing grating coupler 83 only couples a portion of the light transmitted in the layer 72 out of the layer 72, so that another portion of the light generated by the light source 85 may be transmitted onward to the focusing grating coupler 82. Similarly, the focusing grating coupler 82 only couples a portion of the light transmitted in the layer 72 out of the layer 72, so that another portion of the light generated by the light source 85 may be transmitted onward to the focusing grating coupler 81. This may be achieved by appropriately dimensioning the focusing grating couplers 84, 83 and 82 based on the amplitude of the local index of refraction changes.

In one embodiment, the focusing grating couplers 81-84 may have different configurations in order to account for the different distances from the light source 85. Similarly, the various focusing grating couplers arranged in one column so as to couple light into the layer 72 and to focus the light onto respectively one of the electro-optical sensors 95-98 may have different configurations to account for the varying distance of the focusing grating couplers from the associated electro-optical sensor 95-98.

In the proximity sensor device of FIG. 6, light is coupled out of the layer 72 by each one of the focusing grating couplers 81-84 when the light source 85 outputs light. Similarly, when the light source 86 and the light source 87, respectively, output light, the light is coupled out of the layer by plural focusing grating couplers arranged in rows 74 and 75, respectively. Light incident on one of the focusing grating couplers 91-94 is coupled into the layer and transmitted in the layer to one of the electro-optical sensors 95-98, respectively.

By comparing an output signal level of the electro-optical sensors 95-98, which is indicative of a received light intensity, in a state in which neither one of the light sources 85-87 emits light with an output signal level in a state in which one of the light sources 85-87 emits light, it may be determined whether an object is located in proximity to one of the input/output couplers. Based on the electro-optical sensor 95-98 at which the signal is detected and based on the active light source, a location at which an object is positioned in proximity to the layer 72 may be derived.

For illustration, when light is output by the light source 85, each one of the focusing grating couplers 81-84 couples a portion of the light out of the layer, as schematically illustrated at 102, 105 and 107. A portion of the light coupled out of the layer may be reflected at a surface of an object 101, 104 toward the focusing grating couplers 91-94, as indicated at 103, 106 and 108. The reflected portion of the light is coupled into the layer by the focusing grating couplers 91, 93 and 94, respectively, and transmitted in the layer to the electro-optical sensors 95-98, where it is detected. Based on the active light source 85 and the electro-optical sensors 95, 97 and 98 it may be determined that an object 101 is located in proximity to the input/output couplers 81, 91, and that one or several objects are located in proximity to the input/output couplers 83, 94 and 84, 94.

In a proximity sensor device according to an embodiment, in which plural input/output couplers are provided in a layer to couple light out of the layer and into the layer, respectively, object proximity may be sensed in a spatially resolved manner. Therefore, a thus configured proximity sensor device may be used to implement a user interface in which actions or processes may be initiated or controlled by a user. The control may be effected without requiring the user to directly contact a portion of the electronic apparatus. For illustration, user actions such as scrolling through items displayed on a display, selecting items displayed on a display or similar may be performed when an object, such as a user's finger, hovers above the layer of the proximity sensor device.

In a proximity sensor device having plural input/output couplers provided in a layer, the number of detectable object positions may be larger than the number of input/output couplers.

Referring again to FIG. 6, when a reflected light signal is detected by the electro-optical sensors 97, 98 associated with adjacent columns and/or adjacent rows of the input/output coupler arrangement, it may be determined that an object is located at an intermediate position between the respective columns and/or rows. For illustration, the object 104 gives rise to reflected light being detected both by the electro-optical sensor 97 and by the electro-optical sensor 98, which indicates that the object 104 is located at a position between the rows associated with the electro-optical sensor 97 and 98, respectively.

A proximity sensor device having plural input/output couplers provided in a layer may allow object proximity to be sensed with a spatial resolution not only as regards coordinates parallel to the layer, but also as regards a distance from the layer plane. In an embodiment, a number of input/output couplers at which a reflected light signal is coupled into the plane, i.e., a number of input/output couplers at which object proximity is sensed, may be used to estimate the distance of the object from the plane of the layer.

In other proximity sensor devices, a plurality of input/output couplers may be formed in a layer which are configured to couple light out of the layer and into the layer in a wavelength-selective manner. In an embodiment, at least two of the input/output couplers may be configured to provide a good coupling efficiency for light having different wavelengths. Proximity sensing with a spatial resolution may also be implemented using wavelength-selective input/output couplers.

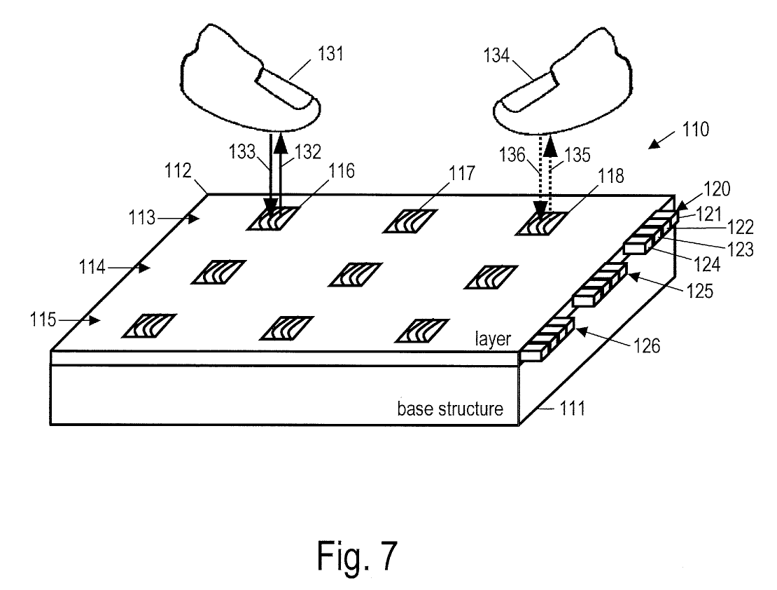

FIG. 7 is a schematic view of a proximity sensor device 110 according to another embodiment. The proximity sensor device 110 comprises a layer 112, a plurality of arrangements 120, 125 and 126 which respectively include several light sources 121-123 and at least one electro-optical sensor 124. While the arrangements are schematically illustrated to include several light sources 121-123 in FIG. 7, in other embodiments the arrangements 120, 125 and 126 may include one light source or several light sources configured to output light at plural different wavelengths, rather than separate light sources configured to output light at plural different wavelengths. The layer 112 is supported by a base structure 111. In the layer 112 a plurality of input/output couplers are provided which may respectively be configured as focusing grating couplers 116-118. The focusing grating couplers 116-118 may respectively be formed by local variations in refractive index in the layer 112, as schematically indicated by curved lines in FIG. 7. The local variations in refractive index may be implemented, for example, by exposing the layer 112 to ultraviolet radiation, by ion-exchange, by locally depositing additional material on the layer 112, by locally removing material from the layer 112, etc.

In the proximity sensor device 110, the plurality of focusing grating couplers are arranged in a plurality of rows 113-115 and in a plurality of columns. The regular arrangement of input/output couplers in a number of rows and columns as shown in FIG. 7 is provided for illustration rather than limitation. Another arrangement of input/output couplers, another number of rows or another number of columns may be implemented in other embodiments.

In an embodiment, the focusing grating couplers arranged in one of the rows 113-115 and associated with one of the light source and sensor arrangements 120, 125, 126 may have different configurations. In an embodiment, the focusing grating couplers arranged in one of the rows 113-115 may be configured so as to respectively have a high coupling efficiency for coupling light out of and into the layer 112 for a wavelength. The wavelengths at which the various focusing grating couplers provide high coupling efficiency may be pairwise different. This may be achieved, for example, by configuring the focusing grating couplers 116-118 in one row such that the spatial dimensions of the changes in refractive index are different for different focusing grating couplers. For illustration, when the focusing grating couplers are implemented by curved regions having a higher or lower refractive index than the other sections of the layer 112, the width and/or spacing of the curved regions may be different for the focusing grating couplers 116, 117 and 118, respectively. Similarly, the focusing grating couplers in the other rows may be configured to have a high coupling efficiency at different wavelengths.

For illustration rather than limitation, the focusing grating coupler 116 may provide a high coupling efficiency at a first wavelength λ1, the focusing grating coupler 117 may provide a high coupling efficiency at a second wavelength λ2, and the focusing grating coupler 118 may provide a high coupling efficiency at a third wavelength λ3. The first, second and third wavelengths λ1, λ2 and λ3 may be pairwise different. Each one of the first, second and third wavelengths λ1, λ2 and λ3 may be a wavelength in the infrared spectral range. The focusing grating couplers in rows 114 and 115 may have a configuration that essentially corresponds to the one of the focusing grating couplers 116-118 in row 113.

Each one of the arrangements 120, 125 and 126 respectively may comprise plural (three in FIG. 7) light sources, such as LEDs, 121-123 which are operable to emit light having different wavelengths. For illustration, the light source 121 may be configured to emit light having the first wavelength λ1, the light source 122 may be configured to emit light having the second wavelength λ2 and the light source 123 may be configured to emit light having the third wavelength λ3. While separate light sources 121-123 are illustrated in FIG. 7, in other embodiments, the function of two or more of these light sources may be integrated into one single light source. For illustration, in another embodiment, one or several of the arrangements 120, 125 and 126 may include at least one light source which is configured to emit light having at least two of the wavelengths λ1, λ2 and λ3. In an embodiment, one or several of the arrangements 120, 125 and 126 may include one light source which is configured to emit light having the wavelengths λ1, λ2 and λ3. Each one of the arrangements 120, 125 and 126 further comprises at least one electro-optical sensor 124. In an embodiment, the electro-optical sensor may be configured to detect light having either one of the first, second and third wavelengths λ1, λ2 and λ3. In another embodiment, each one of the arrangements 120, 125 and 126 may comprise plural electro-optical sensors for detecting light having the first, second and third wavelengths λ1, λ2 and λ3. In another embodiment, one or several of the arrangements 120, 125 and 126 may include an electro-optical sensor configured to determine the detected light energy as a function of wavelength.

In use of the proximity sensor device 110, when the light source 121 outputs light having the first wavelength λ1 into the layer 112, no or only a small portion of the light is coupled out of the layer at the focusing grating couplers 117 and 118, while a larger portion is coupled out of the layer at the focusing grating coupler 116, as indicated at 132. A reflected portion 133 of the light having the first wavelength λ1, reflected at the surface of an object 131, may be coupled back into the layer by the focusing grating coupler 116 and can be detected by the at least one electro-optical sensor 124 of the arrangement 120. Similarly, when the light source 122 outputs light having the second wavelength λ2 into the layer 112, the light is coupled out of the layer 122 mainly at the focusing grating coupler 117. When the light source 123 outputs light having the third wavelength λ3 into the layer 112, the light is coupled out of the layer 122 mainly at the focusing grating coupler 118, as indicated at 135. A reflected portion 136 of the light having the third wavelength λ3, reflected at a surface of an object 134, may be coupled back into the layer by the focusing grating coupler 118 and can be detected by the at least one electro-optical sensor 124 of the arrangement 120. Similarly, by activating light sources in the arrangements 125 and 126 associated with the rows 114 and 115, respectively, proximity of an object may be selectively sensed in volumes defined by the input/output couplers in the rows 114 and 115.

A processor (not shown in FIG. 7), which may be implemented as a general purpose processor or as electrical components forming a processing circuit, is coupled to the light sources and the electro-optical sensors of the arrangements 120, 125 and 126. The processor controls the light sources to output light and evaluates an output signal of the electro-optical sensors to determine at which of the focusing grating couplers light has been coupled into the layer 112. Depending on whether one electro-optical sensor responsive to all wavelengths λ1, λ2 and λ3 or plural electro-optical sensors respectively responsive to one of these wavelengths are provided, the light sources may be controlled such that only one of the light sources 121-123 outputs light at one time, to allow reflected light signals to be assigned to one of the focusing grating couplers 116-118. The light sources 121-123 may be controlled such that each one of the light sources outputs a sequence of light pulses having a wavelength in the infrared spectral range. When the arrangements 120, 125 and 126 respectively include one light source configured to emit light having the wavelengths λ1, λ2 and λ3, several wave-length selective electro-optical sensors or an electro-optical sensor configured to determine the detected light energy as a function of wavelength may be utilized to discrimate at which focusing grating coupler light has been coupled back into the layer.

When light is coupled out of the layer at positions that vary in dependence on the light wavelength, proximity sensing may be performed in a spatially resolved manner. In order to allow light to be coupled out of the layer at positions that vary in dependence on the light wavelength, input/output couplers that have a high coupling efficiency at different wavelengths may be provided in the layer.

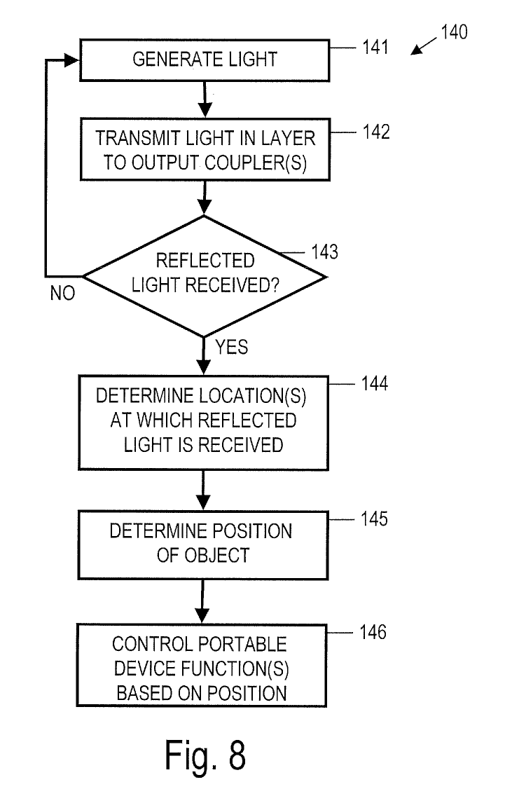

With reference to FIG. 8 a method of sensing proximity of an object according to an embodiment will be explained. The method is generally indicated at 140. The method may be performed by a proximity sensor device according to any one of the embodiments described with reference to FIGS. 6 and 7 above. The method may be used to sense proximity of an object in the portable electronic apparatus 10 of FIG. 1.

At 141, light is generated. Generating light at 141 may include generating light having different wavelengths. The light generated at 141 may be a pulsed signal having a wavelength in the infrared spectral range. At 142, the generated light is transmitted in a layer to an output coupler or to several output couplers provided in the layer. The output coupler or the output couplers couple the light out of the layer. At 143 it is determined whether a reflected light signal is received. The determining at 143 may include coupling the reflected light into the layer. The reflected light may be coupled into the layer at one of plural input couplers provided in the layer. If it is determined at 143 that no reflected light has been received, the method returns to generating light at 141.

If it is determined at 143 that reflected light has been received, at 144 a location or several locations are determined at which the reflected light has been received. When several input couplers are provided in the layer which couple light into the layer, the determining at 144 may comprise determining at which input coupler(s) the reflected light has been coupled into the layer. Determining the input coupler(s) may comprise determining an electro-optical sensor at which the reflected light has been received and determining input coupler(s) associated with the electro-optical sensor. At 145, a position of the object is determined. The determining at 145 may be based on information relating to which light source has generated light at 141, and on information relating to at which input coupler(s) reflected light has been coupled into the layer. In an embodiment, the determining at 145 may comprise determining coordinates of the sensed object along the directions defined by the layer plane. In another embodiment, the determining at 145 may additionally or alternatively comprise determining a distance of the sensed object from the plane.

At 146, one or several functions of a portable electronic apparatus may be controlled based on the position of the object. For illustration rather than limitation an item displayed on a display of the portable electronic apparatus may be selected based on the detected position. For further illustration, when a number pad is displayed on the display, the user may select a number from the number pad by positioning his finger above and spaced from the display for a certain time. In an embodiment, the method may include monitoring a change of position based on the position determined at 145, and one or several functions of the portable electronic apparatus may be controlled based on the monitored change in position.

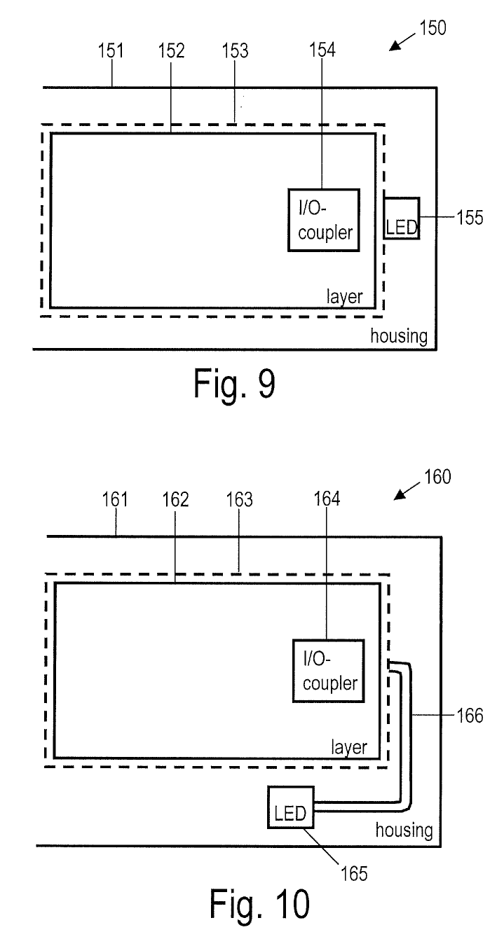

FIG. 9 is a schematic partial view of a portable electronic apparatus 150 which includes a proximity sensor device according to an embodiment. The proximity sensor device comprises a layer 153, an outer boundary of which is shown in broken lines, and a light source 155 optically coupled to the layer 153. An input/output coupler 154, such as a focusing grating coupler, is formed in the layer 153. The proximity sensor device may be configured as proximity sensor device of any one of the embodiments explained with reference to FIGS. 2-8, and may comprise any additional component explained with reference to these proximity sensor devices, such as a processor, an electro-optical sensor, one or several additional input/output couplers, a beam splitter, additional light sources and similar.

The portable electronic apparatus 150 has a housing 151, in which an opening 152 is provided. A part of the layer 153 is located adjacent the opening 152, so as to be exposed through the opening 152. In an embodiment, a boundary of the layer 153 is covered by the housing 151. In operation of the proximity sensor device, light is output by the light source 155, which may be configured as an LED, and is transmitted in the layer to the input/output coupler 154, where at least a portion of the light is coupled out of the layer. When an object is located in proximity to the input/output coupler 154, a reflected portion of the light may be coupled back into the layer by the input/output coupler 154 and may be transmitted in the layer to an electro-optical sensor (not shown in FIG. 9).

As light may be transmitted in the layer 153, a part of which is exposed, and may be coupled out of the layer 153 at the input/output coupler 154, no dedicated opening has to be provided in the housing 151 of the portable electronic apparatus 150 to allow light to be coupled out of the portable electronic apparatus 150 and/or back into the portable electronic apparatus 150. Thereby, the appearance of the portable electronic apparatus 150 may be enhanced.

When the input/output coupler 154 is configured such that it couples light out of the layer 153 in a direction that is essentially perpendicular to the plane of the layer 153, the proximity sensor device 150 allows an objected to be detected at a position above the layer 153, without requiring the light source 155 to be positioned below the layer 153. Rather, as light may be transmitted in the layer 153 and may be coupled out of the layer 153 and back into the layer 153 at the input/output coupler 154, the light source 155 may be positioned at any suitable position that allows the light source 155 to be optically coupled to the layer 153. For illustration, the light source 155 may be positioned so as to be hidden from view, at a location covered by the housing 151 of the portable electronic apparatus. Similarly, the electro-optical sensor (not shown in FIG. 9) may be positioned at any suitable location that allows the electro-optical sensor to be optically coupled to the layer 153. Thereby, in embodiments, enhanced flexibility is provided in positioning a light source and an electro-optical sensor of a proximity sensor device.

FIG. 10 is a schematic partial view of a portable electronic apparatus 160 which includes a proximity sensor device according to an embodiment. The proximity sensor device comprises a layer 163, an outer boundary of which is shown in broken lines, and a light source 165. An input/output coupler 164, such as a focusing grating coupler, is formed in the layer 163. The proximity sensor device may be configured as proximity sensor device of any one of the embodiments explained with reference to FIGS. 2-8, and may comprise any additional component explained with reference to these proximity sensor devices. In the portable electronic apparatus 160, the layer 163 is arranged such that a part of the layer 163 is exposed through an opening 162 provided in a housing 161 of the portable electronic apparatus 160 and the outer boundary of the layer 163 is covered by the housing 161.

In the portable electronic apparatus 160, the light source 165 is not disposed adjacent the layer 163, but rather is spaced from the layer 163. An optical fiber 166 connected to the light source 165 and the layer 163 provides for the optical coupling between the light source 165 and the layer 163. In an embodiment, an electro-optical sensor (not shown in FIG. 10) may also be arranged spaced from the layer 163, and an optical fiber may be provided to optically couple the electro-optical sensor with the layer 163. When optical fibers are used to optically couple the light source and/or electro-optical sensor with the layer 163, additional flexibility in positioning the light source and electro-optical sensor may be achieved.

In the electronic apparatuses and in the proximity sensor devices according to the embodiments described with reference to FIGS. 1-10, components of the proximity sensor device may be comprised by or otherwise associated with other components of the electronic apparatus.

In some embodiments, the layer of the proximity sensor device may be comprised by or otherwise combined with a touch-sensitive device of an electronic apparatus. In an embodiment, the layer of the proximity sensor device may be an outermost layer of a touch-sensitive device. The touch-sensitive device may be, for example, one of a touch pad, a touch screen, a resistive touch screen, a capacitive touch screen, an in-cell touch screen, a touch window or similar.

In some embodiments, the layer of the proximity sensor device may be comprised by or otherwise combined with a display device of a portable electronic apparatus. In an embodiment, the layer of the proximity sensor device may be an outermost layer of a display device. In yet another embodiment, the layer of the proximity sensor device may be comprised by or otherwise combined with a touch-sensitive device and a display device.

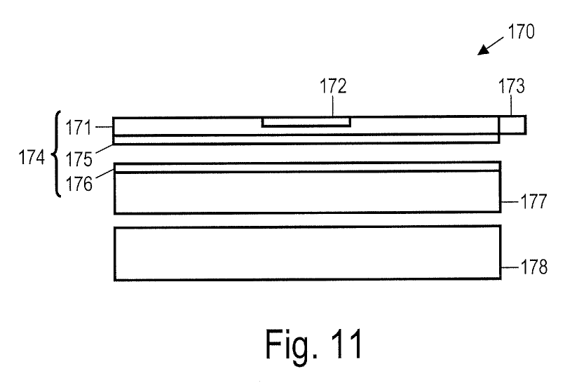

FIG. 11 shows a schematic cross-sectional view of an arrangement 170 which includes a proximity sensor device, a touch screen and a display. The proximity sensor device comprises a layer 171 configured to transmit light and a light source and electro-optical sensor unit 173 optically coupled to the layer 171. In the layer 171, an input/output coupler 172 is provided, which may be formed for example as a focusing grating coupler. The proximity sensor device of the arrangement of 170 may have the configuration of any one of the embodiments explained with reference to FIGS. 1-10.

The arrangement 170 further comprises a touch screen 174, which includes the layer 171 of the proximity sensor as an outermost layer. The touch screen may be configured in a number of ways, for example as a resistive or capacitive touch screen. For illustration, the touch screen 174 may include a conductive coating 175 applied on the layer 171, and another conductive coating 176 applied on a base layer 177 to form a touch screen. In the touch screen, a change in electrical properties may be monitored to detect that the layer 171 is touched, in which case the layer 171 may deflect toward the layer 177 so as to modify electrical characteristics of the conductive coatings 175, 176.

The arrangement 170 further comprises a display panel 178 configured to emit light in the visible spectrum. When combined with a display panel, the layer 171 of the proximity sensor device may be configured to be transmissive in the visible spectral range. In an embodiment, the input/output coupler 172 provided in the layer 171 of the proximity sensor device is configured such that it does not cause a significant refraction, reflection or absorption of the visible light emitted by the display panel 178 in a direction substantially perpendicular to the plane defined by the layer 171.

When a proximity sensor device according to any one embodiment of the invention is combined with a touch-sensitive device, different processes or acts may be initiated in an electronic apparatus depending on whether an object is detected to be located in proximity to the layer or to touch the layer.

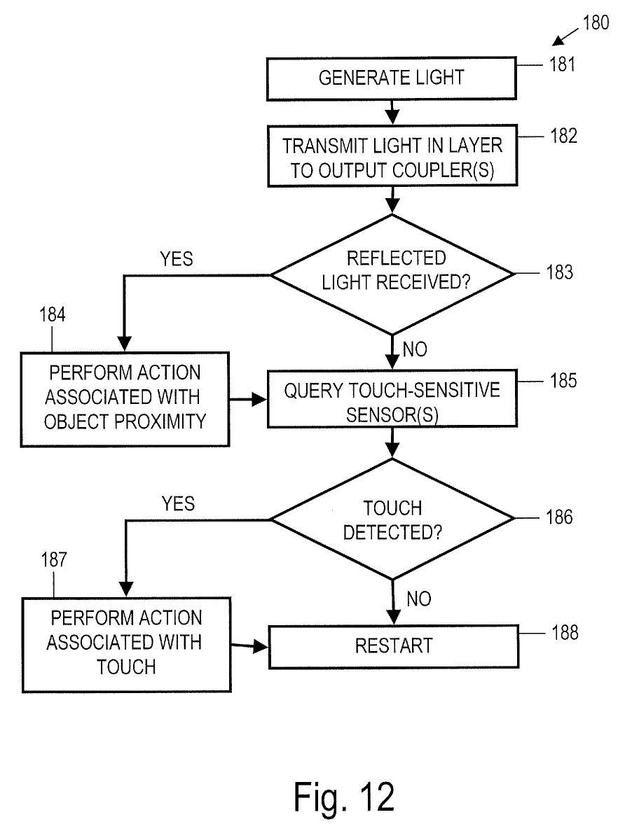

With reference to FIG. 12, a method of controlling an electronic apparatus which includes steps of sensing object proximity will be explained. The method is generally indicated at 180. The method 180 may be performed using a proximity sensor device according to any one embodiment in combination with a touch-sensitive device.

At 181, 182 and 183, light is generated, transmitted in a layer to one or several output couplers, and it is determined whether a reflected light signal is received. The acts at 181, 182 and 183 may be implemented as explained with reference to the corresponding acts at 61-63 in the method 60 of FIG. 5 or as explained with reference to the corresponding acts at 141-143 in the method 140 of FIG. 8.

If it is determined at 183 that reflected light is received, at 184 an action associated with proximity of an object to the layer is performed. If it is determined at 183 that no reflected light is received, or after performing the action associated with proximity of an object at 184, the method proceeds to querying a touch-sensitive device in order to determine whether a touch is detected. The touch-sensitive device may be, for example, one of a touch pad, a touch screen, a resistive touch screen, a capacitive touch screen, an in-cell touch screen, a touch window or similar. At 186 it is determined whether a touch is detected. If it is determined at 186 that a touch is detected, at 187 an action associated with a touch may be performed. If it is determined at 186 that no touch is detected, or after performing the action associated with a touch at 187, the method 180 may restart at 188 and may return to 181 in order to sense object proximity.

The actions associated with object proximity and touch, respectively, may be distinct. For illustration rather than limitation, when a plurality of items is displayed on a display of a portable electronic apparatus, an item may be selected based on object proximity, and the selection may be activated by touch. A user may change a selected item by moving his finger or another object in proximity to, but spaced from, the layer of the touch-sensitive device, and may activate his selection by touching the layer.

While proximity sensor devices, electronic apparatuses and methods of sensing object proximity according to various embodiments have been described, it is to be understood that various changes and modifications may be implemented in other embodiments. For illustration rather than limitation, while proximity sensor devices having a specific number of input/output couplers arranged in a regular arrangement have been explained, any other number of input/output couplers may be implemented in other embodiments. The number of input/output couplers may be selected based on the requirements of the contemplated field of application of the proximity sensor device. While in some embodiments input and output couplers are integrally formed as focusing grating couplers, in other embodiments input and output couplers may be separately provided. While in some embodiments a light source or electro-optical sensor has been illustrated as being located adjacent the layer, the light source or electro-optical sensor may also be disposed so as to be spaced from the layer.

It is to be understood that the features of the various embodiments may be combined with each other. For illustration rather than limitation, the proximity sensor devices of any one of the embodiments described with reference to FIGS. 1-10 may be combined with a touch-sensitive device and/or a display, as explained with reference to FIG. 11. Those skilled in the art will thus appreciate from the foregoing description that the teachings of the present invention can be implemented in a variety of forms.

The proximity sensor devices according to various embodiments may be used in various electronic apparatuses, including portable electronic apparatuses. Exemplary devices in which the proximity sensor devices may be used include, but are not limited to, a mobile phone, a cordless phone, a personal digital assistant (PDA), a portable music player, a camera and the like.

While specific exemplary embodiments of the invention are disclosed herein, various changes and modifications can be made in other embodiments without departing from the scope of the invention. The present embodiments are to be considered in all respect as illustrative and non-restrictive, and the scope of the invention is intended to be limited only by the appended claims and equivalents thereof.

What is claimed is:

1. A proximity sensor device, comprising:
a light source configured to output light; and
a layer optically coupled to said light source to receive said light output by said light source and configured to transmit said light output by said light source in said layer, said layer comprising:
an output coupler configured to couple at least a portion of said light transmitted in said layer out of said layer.

2. The proximity sensor device of claim 1, further comprising:
an electro-optical sensor configured to detect a reflected portion of said light coupled out of said layer.

3. The proximity sensor device of claim 2,
wherein said layer further comprises:
an input coupler configured to couple light into said layer;
wherein said electro-optical sensor is optically coupled to said layer to receive at least a portion of said light coupled into said layer.

4. The proximity sensor device of claim 3,
wherein said input coupler and said output coupler are integrally formed as a grating coupler.

5. The proximity sensor device of claim 4,
wherein said layer further comprises:
a beam splitter configured to direct said light output by said light source to said grating coupler and to direct said light coupled into said layer to said electro-optical sensor.

6. The proximity sensor device of claim 2, further comprising:
a processor coupled to said electro-optical sensor and configured to determine based on an output signal of said electro-optical sensor whether an object is located in proximity to said layer.

7. The proximity sensor device of claim 1,
wherein said light source is configured to output said light with a wavelength in the infrared spectral range.

8. The proximity sensor device of claim 1,
wherein said layer defines a plane, and
wherein said output coupler is configured to direct said light out of said plane.

9. The proximity sensor device of claim 1,
wherein said layer is a layer of a touch-sensitive sensor panel.

10. The proximity sensor device of claim 9, further comprising:
a display panel arranged to co-extend with said layer, wherein said layer is transmissive in the visible spectral range.

11. A proximity sensor device, comprising:
a layer configured to transmit light therein, wherein said layer comprises:
a plurality of output couplers, wherein each output coupler of said plurality of output couplers is respectively configured to couple light out of said layer; and
at least one input coupler, wherein each input coupler of said at least one input coupler is respectively configured to couple light into said layer;
at least one light source optically coupled to said layer and configured to output light to said layer; and
at least one electro-optical sensor optically coupled to said layer and configured to detect at least a portion of said light coupled into said layer by said at least one input coupler.

12. The proximity sensor device of claim 11, further comprising:
a processor coupled to said at least one electro-optical sensor and configured to determine at which input coupler said light is coupled into said layer.

13. The proximity sensor device of claim 11,
wherein said plurality of output couplers and said at least one input coupler are configured as an array of input/output grating couplers.

14. An electronic apparatus, comprising:
a proximity sensor device, said proximity sensor device comprising:
a light source configured to output light; and
a layer optically coupled to said light source to receive said light output by said light source and configured to transmit said light output by said light source in said layer, wherein said layer comprises an output coupler configured to couple at least a portion of said light transmitted in said layer out of said layer.

15. The electronic apparatus of claim 14,
wherein said layer is integrated in an outer shell of said electronic apparatus.

16. A method of sensing proximity of an object, said method comprising:
transmitting light in a layer;
coupling at least a portion of said light out of said layer;
detecting a reflected portion of said light coupled out of said layer; and
determining whether said object is located in proximity to said layer based on said detected reflected portion.

17. The method of claim 16, further comprising:
coupling said reflected portion back into said layer.

18. The method of claim 17, further comprising:
determining a location at which said reflected portion is coupled back into said layer.
